(19) United States
(12) Patent Application Publication
(10) Pub. No.: US 2020/0246213 A1
(43) Pub. Date: Aug. 6, 2020

(54) DEVICE FOR TREATMENT OF EDEMA AND OTHER SKIN AND TISSUE AILMENTS

(71) Applicant: KCL Therapeutics, LLC, Durham, NC (US)

(72) Inventor: Lynda Burt McHutchison, Durham, NC (US)

(21) Appl. No.: 16/268,561

(22) Filed: Feb. 6, 2019

(51) Int. Cl. A61H 15/00

(52) U.S. Cl. CPC A61H 15/0092; A61H 2015/0021; A61H 2201/1635; A61H 2201/1253; A61H 2015/0057

(57) ABSTRACT

A device for treating edema and other skin and tissue ailments is provided. The device includes a section of flexible material, a first handle carried at a first end of the section of material, and a second handle carried at a second end of the section of material. The flexible material extends through opening of each of an array of roller wheels. Each wheel defines a patient engaging outer surface formed from foam or cushion material.

### BACKGROUND

### Field of the Invention

The present invention relates to device for treatment of edema, and, more particularly, towards a device that includes an array of soft roller wheels for massaging a portion of a patient and facilitating venous flow. The device may be for inpatient or outpatient use.

### Description of Related Art

This invention relates generally to resolving swelling and induration of the soft tissue, and more specifically to methods and apparatus for enhancing and directing interstitial fluid movement, stimulation of the lymphatic system and reduction of fibrin formation.

Soft tissue swelling/edema and fibrosis are classic manifestations of the inflammatory process associated with acute/sub-acute injury, repetitive stress to tendons and/or ligaments, and degenerative conditions affecting the joints. An accumulation of plasma proteins and cellular waste within the interstitial fluid resulting from an impairment of the lymphatic system, presents as indurate/fibrotic tissue and swelling, most commonly affecting a body segment or quadrant.

Edema occurs when the rate of fluid filtration out of the capillary bed exceeds the ability of the lymphatic drainage system to return the filtered fluid to the vascular system. Swelling poses a threat because it compromises diffusion and osmosis in microcirculation. Added fluid in the interstitial space increases the distances that substances such as, nutrients and oxygen from the arterioles to the cells and bacteria, proteins and dead cells to the lymphatics must travel, this disruption in fluid dynamics creates a state of cellular starvation. As interstitial pressure rises, the gradient against which the lymphatics must pump is diminished, and the volume of fluid they pump increases, fluid begins to accumulate in the tissue and expand this space.

Manners to treat this condition including massaging the area, however, this is particular problematic for outpatient treatment where a patient of poor health may be required to massage themselves, having to reach difficult locations. Additionally, traditional devices may have a harder than desirable contact surface that leads to pain or discomfort for the patient, and then adherence to the treatment plan may be compromised. Other methods may include compression, such as compression garments.

Accordingly, there is a need for an improved manner of treating edema, particularly for outpatient settings.

### BRIEF SUMMARY

According to one embodiment of the present invention, a device for treating edema and other skin and tissue ailments is provided. The device includes a section of flexible material, a first handle carried at a first end of the section of material, and a second handle carried at a second end of the section of material. The flexible material extends through opening of each of an array of roller wheels. Each wheel defines a patient engaging outer surface formed from foam or cushion material.

According to one or more embodiments, the section of flexible material defines a length between the first handle and the second handle. The array or roller wheels, when arranged such that their respective openings are coaxially aligned and in abutting relationship, define a length thereof that is less than the length of flexible material between the first handle and the second handle.

According to one or more embodiments, each of the roller wheels defines an inner race of a first material. The first material defines a greater durometer hardness than the material forming the patient engaging outer surface. The softness of the roller wheels is an advantage over conventional systems because hard roller wheels can cause bruising.

According to one or more embodiments, the flexible material can be elongated by applying extension forces to the flexible material.

According to one or more embodiments, each of the roller wheels defines a cylindrical cross-section.

According to one or more embodiments, in operation, a user grasps both of the first handle and the second handle and extends the device around a body portion before translating the device generally along a length of the body portion.

According to one or more embodiments, the device includes a cuff on the flexible material to define a stop to limit translation of the array of roller wheels along the flexible material.

According to one or more embodiments, the foam has a shore A durometer hardness of between about 1 and about 20.

### BRIEF DESCRIPTION OF THE SEVERAL VIEWS OF THE DRAWINGS

FIG. 1 illustrates a device according to one or more embodiments disclosed herein;

FIG. 2 illustrates the device of FIG. 1 where the device has been contoured around a body part according to one or more embodiments disclosed herein;

FIG. 3 illustrates a user manipulating the device about the user's body according to one or more embodiments disclosed herein;

FIG. 4 illustrates a side view of a roller wheel for use with the device according to one or more embodiments disclosed herein; and

FIG. 5 illustrates the device of FIG. 1 where the array of roller wheels are closely spaced according to one or more embodiments disclosed herein.

### DETAILED DESCRIPTION

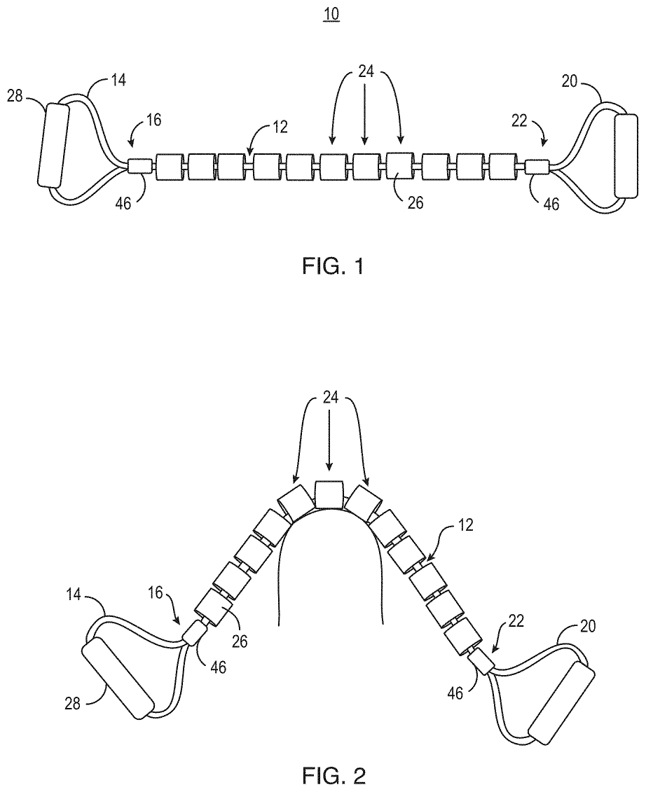

With reference now to FIG. 1, a device 10 for treating edema and other skin and tissue ailments is disclosed. The device 10 may be used in an inpatient or outpatient setting, and may be used along many anatomical parts of the patient.

The device 10 may include a section of flexible material 12. The flexible material 12 may be any appropriately configured material, and in some embodiments may allow for torsional rotation but not allow for elongation. Alternatively, the flexible material 12 may be elongatable by pulling on the flexible material. The flexible material 12 may have any appropriately configured dimension and may be formed from any appropriately configured material.

The flexible material 12 may include a first handle 14 carried at a first end 16 of the section of material 12. The handle 14 is shown as being formed from a loop of the flexible material 12 but may take on many other constructions. A second handle 20 is carried at a second end 22 of the section of material 12. Advantageously, it may be constructed similarly to the first handle 14.

An array 24 of roller wheels 26 may be provided. Each wheel 26 defines an opening 30 passing through a longitudinal 32 thereof. The number of roller wheels 26 making up the array 24 may be variable. In operation, the flexible material 12 extends through the opening 30 of each wheel 26. With further reference to FIG. 4, each wheel 26 may define a patient engaging outer surface 36. The patient engaging outer surface 36 may be formed from foam or cushion material, or any other appropriate material. The material should be generally soft in nature, with a shore A durometer hardness of between 1 and about 20. Each of the roller wheels 26 defines an inner race 44 of a first material. The first material defines a greater durometer hardness than the material forming the patient engaging outer surface 36. This advantageously provides a durable inner race 44 that allows for rotation of the roller wheels 26 about the flexible material 12, and also allows for a mounting surface for the much softer patient engaging outer surface 36 material to be applied to, while providing a soft and comforting surface for applying treatment forces to the patient. In one or more embodiments, each roller wheel defines a generally cylindrical or tubular in cross-section. A cuff 46 may be provided on the flexible 12 material to define a stop to limit translation of the array 24 of roller wheels 26 along the flexible material 12. Grips 28 may also be provided.

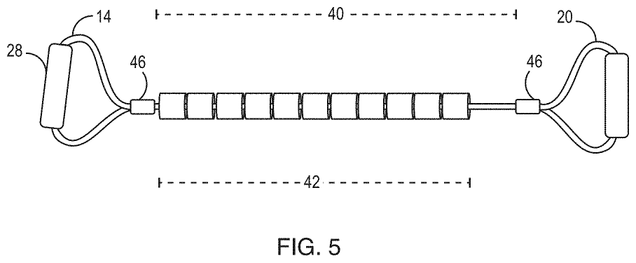

The section of flexible material 12 defines a length 40 between the first handle 14 and the second handle 20. The array 24 or roller wheels 26, when arranged such that their respective openings are coaxially aligned and in abutting relationship, define a length 42 thereof that is less than the length 40 of flexible material 12 between the first handle 14 and the second handle 20. This is illustrated in FIG. 5. This advantageously allows the array 24 of roller wheels 26 to contour to an arcuate or otherwise rounded body shape, such as that which is illustrated in FIG. 2.

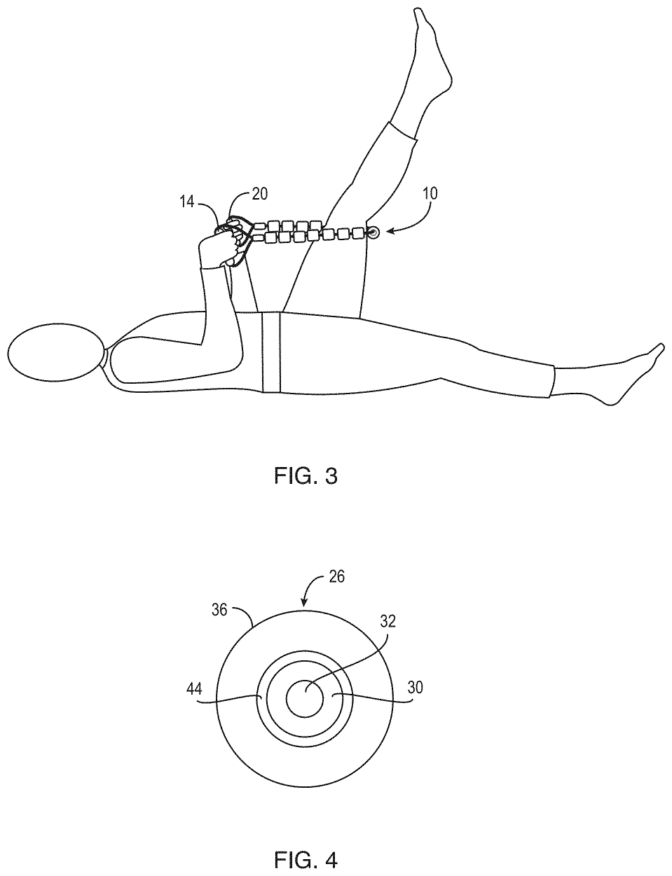

One embodiment of operation of the device is illustrated in FIG. 3. A user is lying on the floor and extends device 10 around their leg, the leg being in an elevated position. The user grabs each of the handles 14 and 20 and then translates the device 10 along a length of the leg to massage the impacted areas. Notably, the device 10 may be employed to treat other areas of the patient, including shoulder, back, other portions of the legs, and the like.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device for treating edema and other skin and tissue ailments, the device comprising:
a section of flexible material;
a first handle carried at a first end of the section of material;
a second handle carried at a second end of the section of material;
an array of roller wheels, each wheel defining an opening passing through a longitudinal thereof, wherein the flexible material extends through the opening of each wheel,
wherein each wheel defines a patient engaging outer surface formed from foam or cushion material.

2. The device of claim 1, wherein the section of flexible material defines a length between the first handle and the second handle, wherein the array or roller wheels, when arranged such that their respective openings are coaxially aligned and in abutting relationship, define a length thereof that is less than the length of flexible material between the first handle and the second handle.

3. The device of claim 1, wherein each of the roller wheels defines an inner race of a first material, wherein the first material defines a greater durometer hardness than the material forming the patient engaging outer surface.

4. The device of claim 1, wherein the flexible material can be elongated by applying extension forces to the flexible material.

5. The device of claim 1, wherein each of the roller wheels defines a cylindrical cross-section.

6. The device of claim 1, wherein, in operation, a user grasps both of the first handle and the second handle and extends the device around a body portion before translating the device generally along a length of the body portion.

7. The device of claim 1, further comprising a cuff on the flexible material to define a stop to limit translation of the array of roller wheels along the flexible material.

8. The device of claim 1, wherein the foam has a Shore A durometer hardness of between about 1 and about 20.

9. A device for treating edema and other skin and tissue ailments, the device comprising:
a section of flexible material;
a first handle carried at a first end of the section of material;
a second handle carried at a second end of the section of material;
an array of roller wheels, each wheel defining an inner race having an opening passing therethrough, the inner race having a shore A hardness of between about 1 and about 20,
wherein the flexible material extends through the opening of each wheel to carry the array of roller wheels about the flexible material,
wherein each wheel defines a patient engaging outer surface formed from a material having a shore D hardness of at least about 10.

10. The device of claim 9, wherein the section of flexible material defines a length between the first handle and the second handle, wherein the array or roller wheels, when arranged such that their respective openings are coaxially aligned and in abutting relationship, define a length thereof that is less than the length of flexible material between the first handle and the second handle.

11. The device of claim 9, wherein each of the roller wheels defines an inner race of a first material, wherein the first material defines a greater durometer hardness than the material forming the patient engaging outer surface.

12. The device of claim 9, wherein the flexible material can be elongated by applying extension forces to the flexible material.

13. The device of claim 9, wherein each of the roller wheels defines a cylindrical cross-section.

14. The device of claim 9, wherein, in operation, a user grasps both of the first handle and the second handle and extends the device around a body portion before translating the device generally along a length of the body portion.

15. The device of claim 9, further comprising a cuff on the flexible material to define a stop to limit translation of the array of roller wheels along the flexible material.
